(19) United States
(12) Patent Application Publication
(10) Pub. No.: US 2018/0218565 A1
(43) Pub. Date: Aug. 2, 2018

(54) LOTTERY TICKET DISPENSER UNIT WITH VIDEO SCREEN UNIT

(71) Applicant: Owner Revolution Inc., Adair, IA (US)

(72) Inventor: Tony Pross, Atlantic, IA (US)

(21) Appl. No.: 15/417,442

(22) Filed: Jan. 27, 2017

(51) Int. Cl. G07F 17/32

(52) U.S. Cl. CPC G07F 17/3216; G07F 17/329; G07F 17/3211

(57) ABSTRACT

In accordance with an example of the invention, a video screen unit may include a base having a hook at a first end and at least one tab at a second end and a backplate extending substantially perpendicularly from the base and having a surface upon which a video screen may rest, wherein the hook is configured to engage a catch area of a dispenser and the at least one tab is configured to insert into at least one notch of the dispenser.

### BACKGROUND

### 1. Field

The invention relates to a video screen unit configured to connect to a dispenser. In at least one nonlimiting example embodiment the dispenser is a lottery ticket dispenser.

### 2. Description of the Prior Art

Lottery tickets are often housed in ticket dispensers. The dispensers typically include a body which resembles a box having an open end into which the lottery tickets may be placed. The lottery ticket dispensers also generally include a pivotable housing door to cover the open end of the body to protect to lottery tickets. The housing door generally includes an elongated dispensing aperture through which the ribbon of tickets may pass and be dispensed. In some lottery ticket dispensers the housing door includes a pair of rollers over which tickets pass as they are withdrawn from within the housing.

Some owners of lottery ticket dispensers place advertising materials on the lottery ticket dispensers to advertise specials or products. Video screens, while often used for advertising purpose, are generally not used with lottery ticket dispensers for two reasons. First, the screens themselves are prone to theft unless they are secured in some manner. Second, the screens, since they are generally not secured to the lottery ticket dispensers, are prone to falling off and breaking.

### SUMMARY

As identified in the background section, video screens are generally not used with lottery ticket dispensers since video screens are generally not securable to the lottery ticket dispenser in a manner that would prevent theft or damage. Applicant set out to solve this problem and, as a consequence, developed a novel and nonobvious video screen unit which is attachable to a lottery ticket dispenser in a manner that will prevent theft of the video screen and/or reduce the video screen's tendency to dissociate itself from the lottery ticket dispenser.

In accordance with an example of the invention, a video screen unit may include a base having a hook at a first end and at least one tab at a second end. The video screen unit may further include a back plate extending substantially perpendicularly from the base and the back plate may have a surface upon which a video screen may rest. In at least one nonlimiting example embodiment the hook is configured to engage a catch area of a dispenser and the at least one tab is configured to insert into at least one notch of the dispenser.

In accordance with an example of the invention, a system may include a video screen unit and a dispenser. The video screen unit may include a base having a hook at a first end and at least one tab at a second end. The video screen unit may also include a back plate extending substantially perpendicularly from the base and the back plate may have a surface upon which a video screen may rest. The dispenser may include a catch area receiving the hook and at least one notch receiving the at least one tab. The dispenser may also include a door with an overhang configured to cover the at least one tab when the at least one tab is in the at least one notch.

### BRIEF DESCRIPTION OF THE DRAWINGS

The disclosure will be better understood and when consideration is given to the drawings and the detailed description which follows. Such description makes reference to the annexed drawings wherein:

FIG. 1 is a perspective view of a system in accordance with an example of the invention;

FIG. 2 is a view of a ticket dispenser in accordance with an example of the invention;

FIG. 3 is a perspective view of a video screen unit in accordance with an example of the invention;

FIG. 4 is an exploded view of the video screen unit in accordance with an example of the invention;

FIG. 5 is a side view of the video screen unit in accordance with an example of the invention;

FIGS. 6A-6C are views of the video screen unit attaching to the ticket dispenser in accordance with an example of the invention; and

FIG. 7 is a cross-section view of a catch area in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a video screen unit and a system that uses the video screen unit.

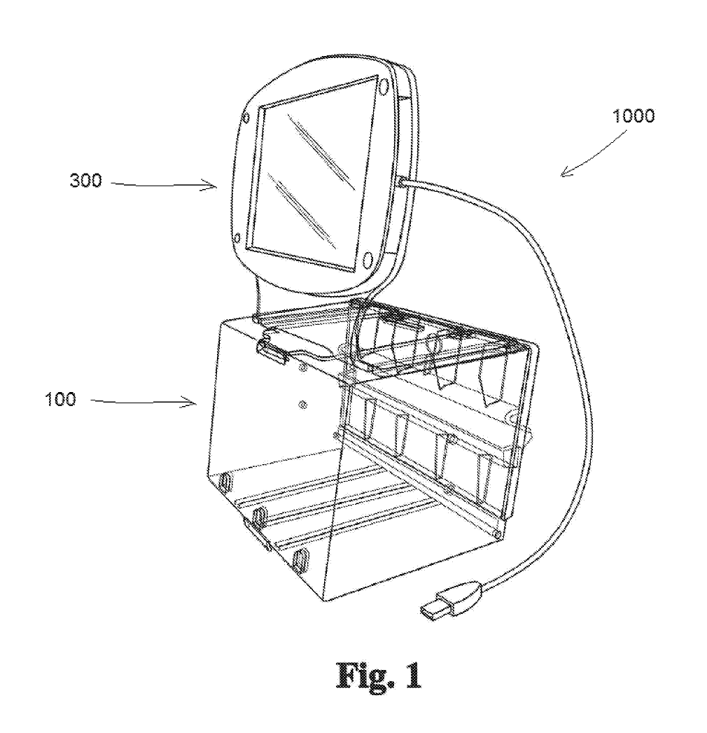

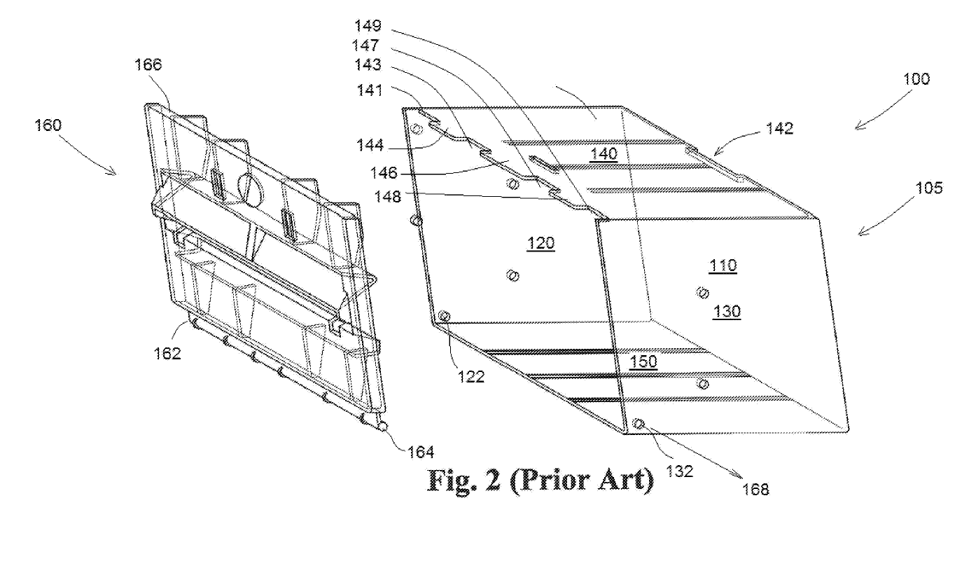

FIG. 1 is a view of a system 1000 comprised of a dispenser 100 and a video screen unit 300. FIG. 2 is a view of the dispenser 100. As shown in FIGS. 1 and 2, the dispenser 100 may resemble a hollow box into which various items, for example, lottery tickets, may be placed. For example, in the nonlimiting example of FIGS. 1 and 2, the dispenser 100 includes a body 105 that includes a front wall 110, a first side wall 120, a second side wall 130, a roof 140, and a floor 150. The body 105, as shown in the figures, may resemble a box with an open end. The dispenser 100 may further include a door 160 that may attach to and seal the body 105 thus protecting contents enclosed by the body 105. The door 160, in one nonlimiting example, may pivotally connect to the body 105. For example, as shown in FIG. 2 the first side wall 120 may include an aperture 122 into which a first post 162 of the door 160 may be inserted and the second side wall 130 may include an aperture 132 into which a second post 164 of the door 160 may be inserted. The post-in-hole configuration may allow the door to pivot about an axis 168 when the door 160 is attached to the body. In the alternative, hinges (not shown) may be provided to pivotally attach the door 160 to the body 105. The hinges may be, for example, butt hinges, projection hinges, parliament hinges, or any other suitable hinge which may allow the door 160 to pivotally attach to the body 105. It is understood the pivotal type connection is not meant to limit the invention as the door 160 is not required to be pivotally connected to the body 105. For example, the door 160 may be press fit onto the body 105 or the door 160 and the body 105 may have members that allow the body 105 to slide onto the body 105 to close the body 105.

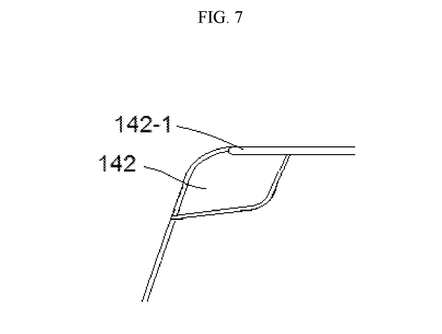

In the nonlimiting example of FIGS. 1 and 2, the roof 140 may have a first end with a plurality of notches between a plurality of tabs. For example, in FIG. 2, the first end of the roof 140 has four (4) notches, 141, 143, 147, and 149 and three (3) tabs 144, 146, and 148. Though FIG. 2 illustrates four (4) notches and three (3) tabs the number of notches and tabs is not necessarily important and there may be more or less than four (4) notches and/or more or less than three (3) tabs. A second end of the roof 140 may include a catch area 142 configured to receive a hook 390 of the video screen unit 300. FIG. 7, for example, shows a closeup/cross-section view of the catch area 142. As shown in FIG. 7, the catch area 142 may resemble a depression with an overhang 142-1 defining a space into which the hook 390 of the video screen unit 300 may be inserted.

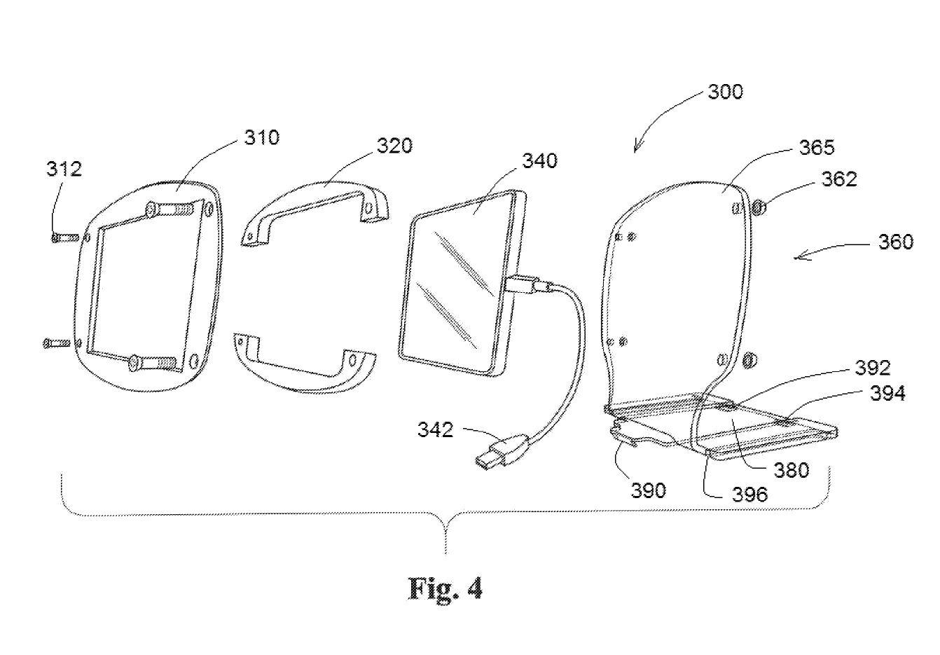

In the nonlimiting example of FIGS. 1 and 2, the door 160 includes an overhang 166 that extends over the tabs 144, 146, and 148 when the door 160 is manipulated to close the body 105. In fact, when the door 160 closes the body 105 when the video screen unit 300 is connected to the dispenser 100 the overhang 166 extends over at least one tab (for example, at least one of tab 392 and 394 of FIG. 4) associated with the video screen unit 300. As will be explained later, this feature allows the video screen unit 300 to attach to the dispenser 100.

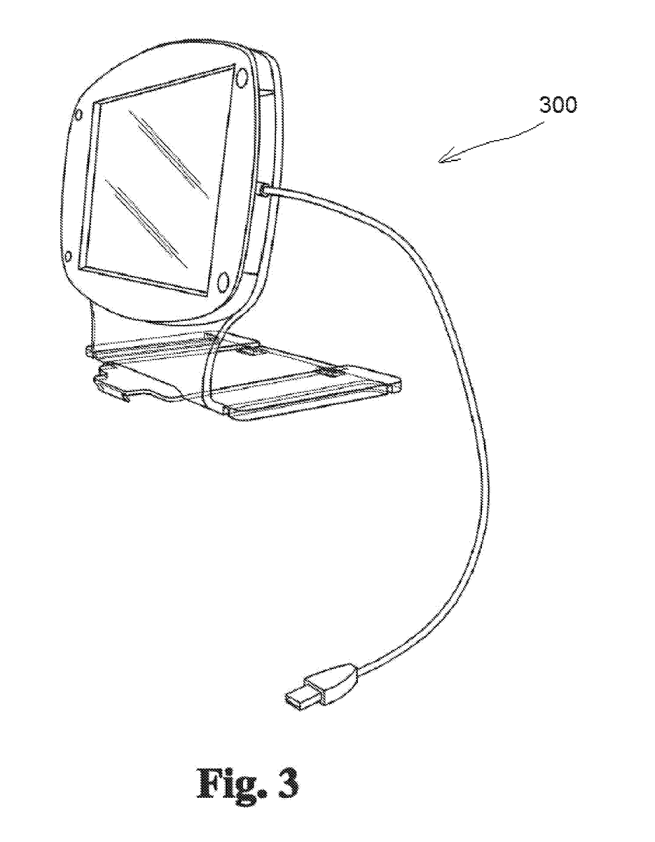

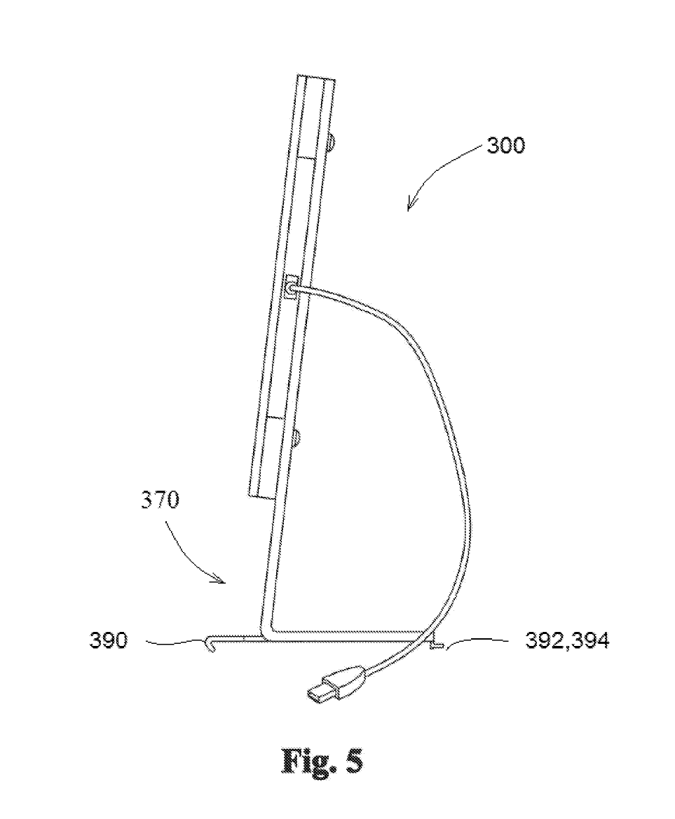

FIG. 3 is a perspective view of the video screen unit 300, FIG. 4 is an exploded view of the video screen unit 300, and FIG. 5 is a side view of the video screen unit 300. Referring to FIGS. 3, 4, and 5, the video screen unit 300 may be comprised of a cover 310, a video screen 340, and a support 360. The support 360 may include a back plate 365, a neck 370, and a base 380. The base 380 may include at least one tab (for example, tab 392 and 394) at a first end of the base 380 and the hook 390 at a second end of the base 380. As will be explained later, the hook 390 and the tabs 392 and 394 may allow the video screen unit 300 to be secured to the dispenser 100.

In at least one nonlimiting example embodiment, the video screen 340 may display various images or moving pictures. For example, the video screen 340 may display various advertisements or products. The video screen 340 may be an electronic screen with a cable 342 that may attach to a computer for power and/or data. On the other hand, the video screen 340 may be constructed with a battery and wireless communication, as such, the cable 342 may not be necessary to the invention.

Referring to FIG. 4, the video screen unit 300 may be assembled by placing the video screen unit 340 on the back plate 365 of the support 360. One or more spacers 320 may be placed on the back plate 365 and adjacent the video screen 340 and the cover 310 may be placed over the spacers 320 so the spacers 320 are sandwiched between the cover 310 and the back plate 365. In the nonlimiting example illustrated in the various figures, the cover 310, spacers 320 and backplate 365 may be connected to each other by a conventional means. For example, in one nonlimiting example embodiment each of the cover 310, the spacers 320, and the back plate 365 include apertures allowing screws 312 to pass therethrough and engage nuts 362 that may be arranged on the back of the back plate 365. This means of fastening, however, is not intended to limit the invention as other fastening means, for example, clips, pins, and/or adhesives, may alternatively connect the cover 310, spacers 320, and back plate 365 together.

As indicated above, the video screen unit 300 includes a hook 390 at a front end. The hook 390 is configured to insert into the catch area 142 of the dispenser 100. Thus, a length of the hook 390 may be about the same size as, or smaller than, a length of the catch area 142. A bottom surface of the base 380 may have a contour which matches the contour of the roof 140 of the dispenser 100. As such, a bottom surface of the base 380 may rest flush on the top surface of the dispenser 100. In addition, various grooves 396 may be cut into the base 380 to allow the cable 342 to reside therein and to capture the cable 342. This will not only prevent the cable 342 from dangling and making it prone to disconnecting from the video screen 340 but can also act as an antitheft measure.

On the back of the base 380 are a pair of tabs 392 and 394. In at least one example embodiment, the tabs 392 and 394 may be spaced so that as if the hook 390 is engaged with the catch area 142 and the base 380 is on the roof 140 the tabs 392 and 394 reside in the notches 143 and 147. The Tabs 392 and 394 may be configured so that ends thereof are covered by the overhang 166 of the door 160 when the door 160 seals the body 100. For example, the tabs 392 and 394 may be L-shaped having a vertical portion extending downward and below a bottom surface of the base 380 and a horizontal portion extending the vertical portion and the overhang 166 may overhang the horizontal portion.

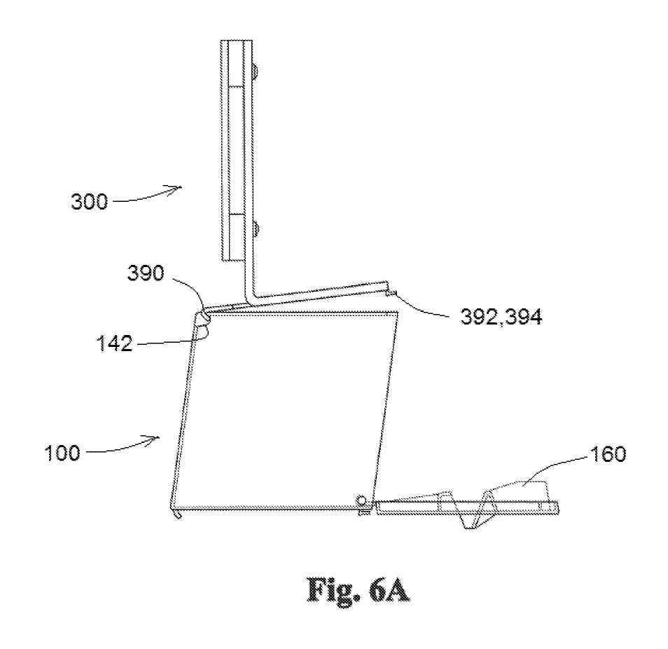

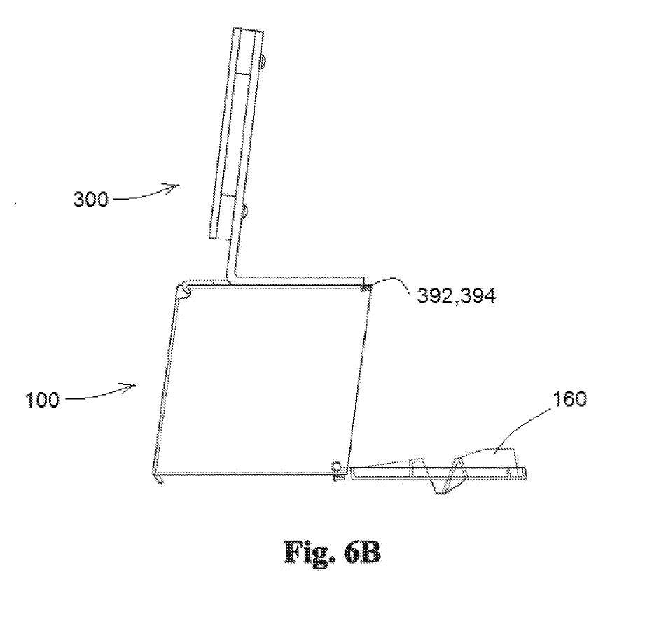

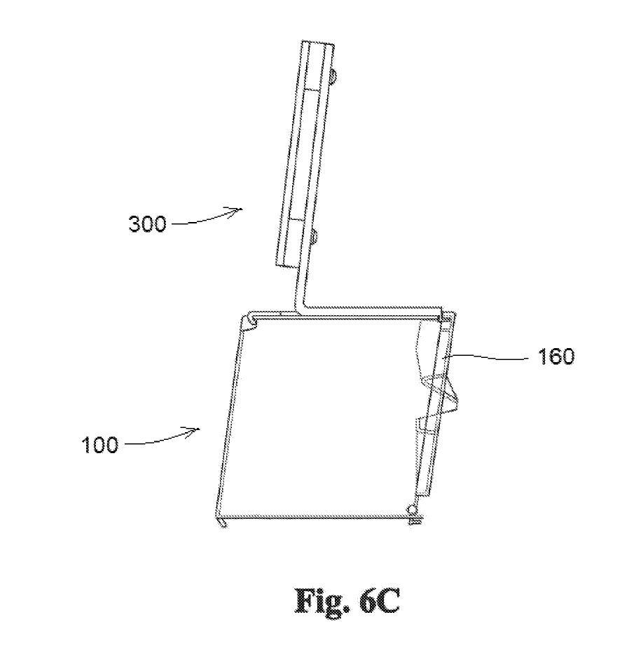

FIGS. 6A, 6B, and 6C illustrate an example of how the video screen unit 300 attaches to the dispenser 100. As shown in FIG. 6A, the video screen unit 300 may be manipulated (for example, tilted) so the hook 390 is engaged in the catch area 142. The video screen unit 300 may then be rotated backwards so tabs 392 and 394 reside in the notches 143 and 147 as shown in FIG. 6B. The door 160 may then be moved (for example rotated) so that the overhang 166 covers each of the tabs 144, 146, and 148 of the dispenser 100 and the tabs 392 and 394 of the video screen unit 300 to secure the video screen unit 300 to the dispenser 100. In this configuration, the video screen unit 300 cannot be removed from the dispenser 100 since the overhang 166 prevents the tabs 392 and 394 from being removed from the notches 143 and 147 and the overhang 142-1 prevents the hook 390 from being removed from the catch area 142. The video screen unit 300, however, can become detached from the dispenser 100 by moving the overhang 166 away (for example by rotating backwards) from the notches 143 and 147 to expose the tabs 144 and 146 and then rotating the video screen unit 300 forward to push the hook 390 out of the catch area 142.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

What is claimed is:

1. A video screen unit comprising:
a base having a hook at a first end and at least one tab at a second end;
a backplate extending substantially perpendicularly from the base and having a surface upon which a video screen may rest, wherein the hook is configured to engage a catch area of a dispenser and the at least one tab is configured to insert into at least one notch of the dispenser.

2. The video screen unit of claim 1, wherein
the at least one tab has an upper surface configured to engage an overhang of the dispenser.

3. The video screen unit of claim 2, wherein the at least one tab is substantially L-shaped.

4. The video screen unit of claim 3, wherein the at least one tab is a pair of L-shaped tabs.

5. The video screen unit of claim 1, where the base includes a least one groove configured to receive a cable.

6. The video screen unit of claim 1, further comprising:
the video screen;
at least one spacer; and
a cover, wherein the video screen is adjacent the back plate and the spacer and the video screen are sandwiched between the cover and the backplate.

7. The video screen unit of claim 7, wherein the cover includes an aperture configured to expose the video screen so an observer may view the video screen.

8. A system comprising:
a video screen unit comprising a base having a hook at a first end and at least one tab at a second end, a backplate extending substantially perpendicularly from the base and having a surface upon which a video screen rests; and
a dispenser comprising a catch area receiving the hook, at least one notch receiving the at least one tab, and a door with an overhang configured to cover the at least one tab when the at least one tab is in the at least one notch.

9. The system of claim 8, wherein the at least one tab is substantially L-shaped.

10. The system of claim 9, wherein the at least one tab is a pair of tabs and the at least one notch is a pair of notches and a spacing of the pair of tabs and a spacing of the pair of notches is substantially the same.
